(19) United States
(12) Patent Application Publication
(10) Pub. No.: US 2004/0157595 A1
(43) Pub. Date: Aug. 12, 2004

(54) Device and method for checking the quality of data packets transmitted via a radio channel

(76) Inventor: Martin Kruger, Munchen (DE)

Correspondence Address: Andreas Grubert, Baker Botts L.L.P., 910 Louisiana, One Shell Plaza, Houston, TX, 77002-4495, US

(21) Appl. No.: 10/772,505

(22) Filed: Feb. 5, 2004

Related U.S. Application Data
(63) Continuation of application No. PCT/DE02/02217, filed on Jun. 18, 2002.

(30) Foreign Application Priority Data
Aug. 16, 2001 (DE) 101 40 114.0

(51) Int. Cl. H04Q 7/20

(52) U.S. Cl. 455/423; 714/786

(57) ABSTRACT

In a device and method for detecting bad or unreliable frames in a radio receiver the threshold values for the number of errors or metric are adapted in dependence on the type of transmission channel. For slowly varying transmission channels, a higher quality is demanded than for rapidly varying transmission channels. The type of transmission channel currently present can be deduced by means of the proportion of data packets having the metric zero.

### CROSS REFERENCE TO RELATED APPLICATION

This application is a continuation of copending International Application No. PCT/DE02/02217 filed Jun. 18, 2002 which designates the United States, and claims priority to German application no. 101 40 114.0 filed Aug. 16, 2001.

### TECHNICAL FIELD OF THE INVENTION

The present invention relates to a device for detecting badly or unreliably transmitted data packets in a radio receiver, particularly in a mobile radio receiver, and a method for detecting badly or unreliably transmitted data packets.

### DESCRIPTION OF THE RELATED ART

In mobile radio transmission, the user data stream to be transmitted is disassembled at the transmitter end into data packets which are then transmitted to the receiver. At the receiver, the received packets are first supplied to a deinterleaver which performs for each data block transmitted a permutation of the data symbols of this data block. The output of the deinterleaver is connected to the input of the receiver's Viterbi decoder which decodes the incoming data stream.

With respect to a received data packet, an assessment must be made as to whether the number of errors occurring within the data packet is still acceptable or whether the received data packet must be discarded. In this case, the data packet would have to be requested again from the transmitter and transmitted to the receiver.

To assess the quality of the transmitted data, it is known to transmit, together with the user data bits, an error protection word which enables the data integrity to be checked at least for some of the user data bits transmitted. To check the data integrity, various checksum methods and cyclic redundancy checks (CRCs) known from coding theory are used. In the simplest of these methods, a parity bit is transmitted together with the sequence of user bits. More complicated checksum methods also provide for error correction in addition to error detection.

In the GSM mobile radio standard, three classes of user bits are distinguished, namely classes Ia, Ib and II. Whereas the transmitted bits of class Ia are transmitted together with an associated error protection word, no such error protection word is provided for the bits of class Ib. The bits of class II are distinguished from the bits of classes Ia and Ib in that, after the deinterleaving, they bypass the Viterbi decoder and can be processed further without any further decoding. In the GSM standard, therefore, a CRC check is only performed for the user bits of class Ia (and thus only for a particular fraction of the user bits transmitted overall). The data packet is either accepted or discarded in dependence on the result of the CRC check.

However, the error probability of the bits of the frames which are not discarded, the so-called residual bit error rate, is still too great in many cases. The ETSI (European Telecommunications Standards Institute) has set strict rules for the residual bit error rate (RBER) for the GSM mobile radio standard. Such rules also exist for the so-called frame erasure rate (FER) which specifies the relative number of discarded frames. Of these two rules, the rule for the residual bit error rate RBER is more difficult to meet. Since, with a checksum test, it is only possible to check the Ia bits for errors and thus only a small proportion of the transmitted bits is covered, the probability for bits with undetected errors of classes Ib and II is very great, often greater than permissible.

To solve this problem, an additional checking method is proposed in US patent specification U.S. Pat. No. 5,113,400 “Error Detection System” by A. F. Gould and P. D. Rasky. For this purpose, the decoded user data stream occurring at the output of the Viterbi decoder is supplied to a convolutional coder which corresponds exactly to the convolutional coder used at the transmitter end. This convolutional coder again codes the decoded data stream. The encoded data stream thus obtained should correspond exactly to the encoded data stream present at the input of the Viterbi decoder. The number of bit errors occurring within a particular data packet can be detected by a comparison of the two data streams which can be performed, for example, by an XOR gate. The number of bit errors determined for a data packet or for a group of data packets, respectively, is called a metric. If the metric exceeds a particular predetermined threshold value or if the checksum test performed in parallel with this is not successful, the frame is discarded. This increases the frame erasure rate FER in every case; the residual bit error rate RBER is lowered. However, this method, in which the metric is compared with a firmly predetermined threshold value, has the disadvantage that the residual bit error rate RBER is still subject to great fluctuations.

For this reason, solutions have been proposed in which the threshold value is adapted to the metric. Such a solution is proposed in U.S. Pat. No. 6,092,230 “Method and Apparatus for Detecting Bad Frames of Information in a Communication System” by S. L. Wood, T. J. Kundmann, L. M. Proctor and K. Stewart. A state machine detects the discarding frequency of frames and varies the threshold value for the metric in such a manner that the relative number of discarded frames, that is to say the frame erasure rate FER, is within a desired range. Using this method, the frame erasure rate FER can be adjusted to a desired value. However, this method is not suitable for controlling the residual bit error rate RBER into a desired range.

It is, therefore, the object of the invention to provide a device and a method for adjusting threshold values in the quality check of received data packets, by means of which severe fluctuations in the residual bit error rate (RBER) can be avoided.

### SUMMARY OF THE INVENTION

This object can be achieved by a device or a radio receiver comprising a device for detecting data packets transmitted not reliably without errors in a radio receiver, particularly in a mobile radio receiver, comprising a convolutional decoder for decoding the received data packets, means for assessing the quality of the decoded data packets with respect to their freedom from errors, comparison means which compare parameters characteristic of the quality of the decoder data packets with threshold values, the data packets being accepted, discarded or modified in dependence on the result of the comparison, means for determining whether the current transmission channel is a rapidly varying transmission channel or a slowly varying transmission channel, and means for establishing the threshold values for the comparison means in dependence on whether the current transmission channel is a rapidly varying transmission channel or a slowly varying transmission channel.

The means for assessing the quality of the decoded data packets may comprise a convolutional coder for recoding the decoded data. The means for assessing the quality of the decoded data packets may comprise at least one XOR operation by means of which the deviations between the received data and the data recoded by the convolutional coder can be detected. The means for assessing the quality of the decoded data packets may comprise an error counter which counts the number of errors as the number of deviations between the received data and the data recoded by the convolutional coder. The comparison means may compare the number of errors determined by the error counter with at least one threshold value, the data packets being accepted, discarded or modified in dependence on the result of the comparison. The determining means may determine by means of the distribution of the frequencies of the various numbers of errors determined for the data packets whether the current transmission channel is a rapidly varying transmission channel or a slowly varying transmission channel. The determining means may determine by means of the proportion of error-free data packets whether the current transmission channel is a rapidly varying transmission channel or a slowly varying transmission channel. The means for determining whether the current transmission channel is a rapidly varying transmission channel or a slowly varying transmission channel may comprise a zero-metric counter which counts the error-free data packets within a predetermined number of data packets. The means for determining whether the current transmission channel can be a rapidly varying transmission channel or a slowly varying transmission channel comprise at least one comparator which compares the number or the proportion of error-free data packets with a zero-metric limit value, the result of the comparison being used for determining whether a rapidly varying transmission channel or a slowly varying transmission channel is present. In the case where the number or the proportion of error-free data packets is above the zero-metric limit value, a higher quality of received data packets with respect to their freedom from errors can be demanded than for the case where the number or the proportion of error-free data packets is below the zero-metric limit value. In the case where the number or the proportion of error-free data packets is above the zero-metric limit value, the threshold values for the comparison means can be set to smaller values than for the case where the number or the proportion of error-free data packets is below the zero-metric limit value. The comparison means for determining data packets having a high degree of errors may perform a comparison between the parameters characteristic of the quality of the data packets and a first threshold value, and the comparison means for determining data packets having a lower degree of errors may perform a comparison between the parameters characteristic of the quality of the data packets and a second threshold value which is smaller than the first threshold value. The transmission channel can be a half-rate channel and, in particular, a half-rate voice channel.

The object can also be achieved by a method for detecting data packets transmitted not reliably without errors in a radio receiver, particularly in a mobile radio receiver, comprising the following steps:

a) determining whether a rapidly varying transmission channel or a slowly varying transmission channel is present;

b) assessing the quality of the decoded data packets with respect to their freedom from errors;

c) establishing threshold values for the required quality of the data packets in dependence on the type of transmission channel determined in step a);

d) comparing parameters characteristic of the quality of the decoded data packets determined in step b) with the established threshold values; and

e) accepting, discarding or modifying the data packets in dependence on the result of the comparison.

In step d), the number of errors determined for each data packet can be compared with at least one threshold value. The distribution of the frequencies of the various numbers of errors determined for that data packets can be used for deducing whether a rapidly varying transmission channel or a slowly varying transmission channel is present. The proportion of error-free data packets can be used for determining whether a rapidly varying transmission channel or a slowly varying transmission channel is present. The error-free data packets can be counted within a predetermined number of data packets, and by comparing the number or the proportion of error-free data packets with a zero-metric limit value, it can be determined whether a rapidly varying transmission channel or a slowly varying transmission channel is present. In the case where the number or the proportion of error-free data packets is above the zero-metric limit value, a higher quality of the received data packets with respect to their freedom from errors can be demanded than for the case where the number or the proportion of error-free data packets is below the zero-metric limit value. In the case where the number or the proportion of error-free data packets is above the zero-metric limit value, the threshold values for the comparison means can be set to smaller values than for the case where the number or the proportion of error-free data packets is below the zero-metric limit value.

The device according to the invention for detecting badly or unreliably transmitted data packets in a radio receiver, particularly in a mobile radio receiver, may comprise a convolutional decoder for decoding the received data packets, means for assessing the quality of the decoded data packets and comparison means which compare parameters characteristic of the quality of the decoded data packets with threshold values and accept, discard or modify the data packets in dependence on the result of the comparison. In addition, the device for detecting badly or unreliably transmitted data packets comprises means for determining the type of transmission channel, which determine whether the current transmission channel is a rapidly varying transmission channel or a slowly varying transmission channel, and means for establishing the threshold values for the comparison means in dependence on the type of transmission channel determined.

The invention is based on the finding that the transmission characteristic of slowly varying (mobile) radio channels differs fundamentally from the transmission characteristic of rapidly varying (mobile) radio channels. A slowly varying transmission channel is, for example, the transmission channel which is set up between a pedestrian calling on his mobile telephone in a municipal environment and the nearest base station (Typical Urban 3 km/h, TU3). In slowly varying transmission channels, there are alternately long periods of good transmission quality and of poor transmission quality. This leads to the transmission quality remaining constant in most cases during the transmission of a data packet—either constantly good or constantly bad. As a consequence the received data, after being decoded, have either no or only very few errors or very many errors.

In the case of rapidly varying transmission channels, in contrast, the transmission quality of the channel changes in shorter intervals. Time intervals with good transmission quality rapidly alternate with time intervals of poor transmission quality. For this reason, the transmission quality changes several times, as a rule, during the transmission of a data packet. Since the user data bits are transmitted with a certain redundancy, parts of a data packet transmitted with errors can be reconstructed, as a rule, by means of other parts of the data packet transmitted without errors, in the convolutional decoder. In the case of rapidly varying transmission channels, the major proportion of the decoded data packets may contain some errors but data packets having a very large number of errors are rare in rapidly varying transmission channels. Data packets completely free of errors also occur only rarely because this requires the transmission quality to be sufficiently good for the entire period needed for the transmission of the data packet. This occurs rarely in rapidly varying transmission channels.

Because of the different transmission characteristic of different physical channels, the residual bit error rate RBER, that is to say the probability of errors occurring in bits which cannot be explicitly checked for errors, also behave differently. In the case of slowly varying transmission channels, the case is basically that if a good transmission period occurs, there are no errors. If, in contrast, bit errors were found for some of the bits checked, the residual bit error rate is very great in the unchecked bits in the case of slowly varying transmission channels because it must be assumed that the entire data packet has been transmitted during a poor transmission period. In the case of rapidly varying transmission channels, in contrast, the residual bit error rate is clearly lower in the case where some bit errors have already been detected.

To account for this dependence of the residual bit error rate on the type of transmission channel, the threshold values for the quality of the decoded data packets are adapted to the type of transmission channel determined in advance in the device according to the invention for detecting badly or unreliably transmitted data packets. If it is found that a slowly varying transmission channel is present, strict threshold values are set for the quality checking. This is because, even if only a few errors occur within the checked part of the transmitted user data, it must be assumed in the case of slowly varying transmission channels that the entire data packet has been transmitted with errors. Even if only a few errors were found within the checked fraction of the user data, the data packet should therefore be discarded.

If, in contrast, it is found that a rapidly varying transmission channel is present, the threshold values for the quality of the decoded data packets can be set more generously. In this case, it must still be assumed that large parts of the data packet have been transmitted correctly even if there are some errors within the checked fraction of the user data sequence.

Using the adaptation of the threshold values in dependence on the type of transmission channel determined, according to the invention, it is possible to achieve the situation in which the residual bit error rate can be kept at an approximately constant value even with changing transmission conditions. This leads to a more uniform transmission quality; fluctuating bit error rates can be avoided by using the solution according to the invention. Using the solution according to the invention also makes it possible to establish an optimum balance between the residual bit error rate RBER and the relative number of discarded frames, the frame erasure rate FER. The determining factor for these successes achieved with the aid of the solution according to the invention is the distinguishing between slowly varying and rapidly varying transmission channels and the understanding of the different transmission characteristic caused by this. Distinguishing whether a slowly varying or a rapidly varying transmission channel is present can be done in a simple and rapid manner by means of some criteria disclosed in this patent application. The circuit complexity of implementing means for determining the type of transmission channel is low.

It is of advantage if the means for assessing the quality of the decoded data packets comprise a convolutional coder for recoding the decoded data. In the convolutional decoder, it is determined, on the basis of the data received via the mobile radio channel, with the aid of the Viterbi algorithm which user data sequence forms the basis of the transmission with the greatest probability. To check this result of the estimation of the convolutional decoder, the decoded data are recoded by means of an additional convolutional coder. By recoding the decoded data, the original encoded bit stream which was supplied to the Viterbi decoder can be compared with the re-encoded bit stream. From the comparison of the two bit streams it is possible to determine the number of bit errors per data packet. The number of deviations or bit errors determined for a particular data packet will be called a metric in the text which follows. This metric, which is obtained by the new convolutional coding of the decoded data, represents an informative characteristic number for the quality of the decoded data packets and is, therefore, particularly suitable for checking the transmission quality.

It is of advantage if the means for assessing the quality of the decoded data packets comprise at least one XOR operation by means of which the deviations between the received data and the data recoded by the convolutional coder can be detected. If matching signal values are applied to the two inputs of an XOR gate, the value “0” is at the output of the XOR gate. If, in contrast, a “0” is present at one of the inputs of the gate and a “1” is present at the other input, the value “1” can be picked up at the output of the XOR gate. An XOR gate is, therefore, particularly suitable for detecting the deviating bits between two bit streams. Each deviation between the two bit streams is indicated by the value “1” at the output of the XOR gate.

It is of advantage if the means for assessing the quality of the decoded data packets comprise an error counter which counts the number of errors as the number of deviations between the received data and the data recoded by the convolutional coder. The encoded data stream of the received data and the data stream of re-encoded data, generated by the convolutional coder, are compared with one another bit by bit and the error counter counts the number of deviations. The error counter supplies for each received data packet the metric of the data packet, that is to say the number of errors determined for the data packet. If the deviations between the received data and the data recorded by the convolutional coder are detected with the aid of an XOR gate, the error counter counts the frequency of occurrence of the signal value “1” at the output of the XOR gate.

In an advantageous embodiment of the invention, the number of errors determined by the error counter is compared by the comparison means with at least one threshold value and the data packets are accepted, discarded or modified in dependence on the result of the comparison. The number of errors or metric is an informative parameter for the quality of the decoded data packets. The higher the metric, the poorer the quality of the decoded data packet. The metric threshold value defines the just acceptable number of errors of the data packet. If the number of errors or metric of the data packet is below the threshold value, the decoded data are trustworthy. If, in contrast, the number of errors determined by the error counter exceeds the threshold value, the data packet must be discarded. Following this, it is possible to request the retransmission of the data packet.

In parallel with the check of the metric of the received data packet, a conventional checksum test (Cyclic Redundancy Check, CRC) can also be performed for some of the transmitted bits, for example for the bits of class Ia. For this purpose, the error protection word transmitted together with the bits of class Ia is used, by means of which the data integrity of the transmitted bits of class Ia can be judged. Using the checksum test, it is possible to judge whether bit errors have occurred within the bits of class Ia, or not. If both the metric has been determined and a CRC check has been performed for a received data packet, the data packet is only accepted if the data are graded as trustworthy by both tests. If, in contrast, the metric is above the threshold value or if the checksum test or CRC check signals the existence of bit errors, the received data packet must be discarded. A quality check by means of the metric of the data packets can, therefore, be combined with the well-established CRC checks, parity checks or checksum tests without problems.

According to a further advantageous embodiment of the invention, the means for determining the type of transmission channel deduce the type of transmission channel by means of the distribution of the frequencies of the various numbers of errors determined for the data packets. The distribution of the frequencies of the numbers of errors makes it possible to determine whether a rapidly varying or a slowly varying transmission channel is present. For this purpose, the associated number of errors is determined for each data packet for a set of data packets. After that, for each possible number of errors i, the frequency ni of their occurrence in the set of data packets considered is determined. By plotting the number of errors i against a frequency ni of their occurrence, a histogram is obtained which has specific peculiarities in dependence on the type of the physical transmission channel. If the histogram of the number of errors for various physical channels is considered with the same signal/noise ratio averaged over time, it is found that the number of errors has two frequency points at zero and at a higher number of errors in the case of slowly varying transmission channels. In the case of rapidly changing transmission channels, in contrast, the histogram of the number of errors drops monotonically from zero. It is particularly the frequency of a zero metric which is particularly high in the case of slowly varying channels, higher than in rapidly varying channels. The reason for this is that a zero metric is produced only if good transmission conditions prevail during the entire period needed for the transmission of the data packet. This case occurs much more frequently in slowly varying channels than in rapidly varying channels in which good and poor transmission periods alternate in rapid succession during the transmission of a data packet. The characteristics of the physical transmission channel can, therefore, be detected from the histogram of the metrics and taken into consideration.

It is particularly of advantage if the means for determining the type of transmission channel determine the type of transmission channel by means of the proportion of error-free data packets. A high proportion of data packets with a zero metric is a typical feature of a slowly varying transmission channel. Using this feature, slowly varying and rapidly varying transmission channels can be distinguished from one another in a simple manner. For this purpose, it is only necessary to determine and count the data packets with the metric of zero within a predetermined number of data packets.

It is of advantage if the means for determining the type of transmission channel comprise a zero-metric counter which counts the error-free data packets within a predetermined number of data packets. During the reception of a predetermined number of data packets, the zero-metric counter is incremented by one for each data packet for which the metric exhibits the value of zero. Such a zero-metric counter can be implemented in hardware in a simple manner and with little expenditure. Using the result supplied by the zero-metric counter, the various types of physical transmission channels can be distinguished in a simple manner.

It is of advantage if the means for determining the type of transmission channel comprise at least one comparator which compares the number or the proportion of error-free data packets with a zero-metric limit value, the result of the comparison being used for determining whether a rapidly varying transmission channel or a slowly varying transmission channel is present. If the proportion of error-free data packets within the received data packets exceeds the zero-metric limit value, a slowly varying transmission channel is present. In the case of slowly varying transmission channels, long time intervals with good transmission quality occur and data packets transmitted within these time intervals have no bit errors at all or only a few. If, in contrast, the proportion of error-free data packets is below the zero-metric limit value, a rapidly varying transmission channel can be assumed. A comparator can be implemented in a simple manner as a comparator circuit with low implementation expenditure. Using the result supplied by the comparator, it is possible to reliably distinguish between the various types of physical channels.

It is of advantage if a higher quality of the received data packets is demanded in the case where the number or the proportion of error-free data packets is above the zero-metric limit value, than for the case where the number or the proportion of error-free data packets is below the zero-metric limit value. This procedure may initially appear to be paradoxical: a high proportion of error-free data packets is intended to lead to a tightening of the quality requirements whereas the quality requirements are even relaxed further with a low proportion of error-free data packets. The reason for this procedure is that it is possible to assume the existence of a slowly varying transmission channel from the presence of many error-free data packets. In the case of slowly varying transmission channels, however, it is reasonable to tighten the quality requirements because the residual bit error rate is high, especially in the case of slowly varying transmission channels. This is because, if transmission errors occur in slowly varying transmission channels, they occur in bursts because the data packet has probably been transmitted completely during a poor transmission period. It is, therefore, sensible to discard such data packets, transmitted via a slowly varying transmission channel, even with relatively low numbers of errors. If, in contrast, the number of error-free data packets is below the zero-metric limit value, a rapidly varying transmission channel is present. In this case, no transmission errors occurring in bursts can be expected because of the rapid sequence of good and poor transmission periods. For this reason, the requirements for the quality of the data packets can be relaxed in the case where the number or proportion of error-free data packets is below the zero-metric limit value.

It is of advantage if, in the case where the number or the proportion of error-free data packets is above the zero-metric limit value, the threshold values for the comparison means are set to lower values than for the case where the number or the proportion of error-free data packets is below the zero-metric limit value. If the number or proportion of error-free data packets is above the zero-metric limit value, the transmission channel is a slowly varying transmission channel. Thus, a higher quality of the received data packets must be demanded. This means that the data packets should be discarded even with a relatively low number of errors and, therefore, the threshold values for the comparison means must be set to relatively low values. If the metric exceeds these relatively low threshold values, the data packet is discarded. If, in contrast, the proportion of error-free data packets is below the zero-metric limit value, it is a rapidly varying transmission channel. Accordingly, the quality requirements are less rigorous and the threshold values, at the transgression of which the corresponding data packet is discarded, can thus be set to comparatively higher values.

In an advantageous embodiment of the invention, the comparison means for determining badly received data packets perform a comparison between the parameters characteristic of the quality of the data packets and a first threshold value. The comparison means for determining unreliably received data packets perform a comparison between the parameters characteristic of the quality of the data packets and a second threshold value, the second threshold value being lower than the first threshold value. In this embodiment of the invention, the additional class of “unreliable frame” is introduced in addition to the class of “poor frame”. Here, too, an unreliable-frame rate (UFR) and an unreliable-frame residual bit error rate (URBER) can be defined. As soon as the error rate of a data packet exceeds the lower, second threshold value, the frame is classified as being unreliable. If the higher, first threshold value is also exceeded, it is also a poor frame which must be discarded in every case. With respect to the unreliable frames, it would be possible, for example, to either retain them or to discard them in dependence on the current frequency of discarded frames. Introducing the additional class of “unreliable frames” makes it possible to achieve an even more uniform quality of the data transmission.

It is of advantage if the transmission channel is a half-rate channel and, in particular, a half-rate voice channel. In the GSM mobile radio standard, data packets with 456 bits are used for full-rate channels whereas data packets with 228 bits are provided in the case of half-rate channels. Because of the greatly reduced redundancy in the data transmission in half-rate channels, both the frame erasure rate FER and the residual bit error rate RBER are checked particularly rigorously in this case. In the case of half-rate voice channels, an added factor is that a voice frame is transmitted distributed over only two time slots instead of four. If such a voice frame is transmitted over a slowly varying transmission channel, the quality requirements are increased when the solution according to the invention is used. This is because, if the transmission of the voice frame takes place completely within a time interval with poor transmission conditions, the probability of a burst-type occurrence of transmission errors is very high.

The invention is particularly suitable for low-expenditure implementation in an integrated circuit in a mobile radio receiver.

In the method according to the invention for detecting badly or unreliably transmitted data packets in a radio receiver, particularly in a mobile radio receiver, it is initially determined whether a rapidly varying transmission channel or slowly varying transmission channel is present. Following that, threshold values are established for the required quality of the data packets in dependence on the type of transmission channel determined. After that, a comparison of parameters characteristic of the quality of the decoded data packets with the established threshold values is performed. The data packets are accepted, discarded or modified in dependence on the result of the comparison.

In the case of fixed threshold values, slowly varying transmission channels have a much higher residual bit error rate than rapidly varying transmission channels. To be able to guarantee a constant transmission quality, the threshold values for the required quality of the data packets are adapted in dependence on the type of transmission channel in the method according to the invention. To achieve a constant residual bit error rate, the threshold values for slowly varying transmission channels are set to lower values than the threshold values for rapidly varying transmission channels. The parameters characteristic of the quality of the decoded data packets, for example the metric, are compared with the established threshold values. When the threshold values are exceeded, the data packets are discarded.

### BRIEF DESCRIPTION OF THE DRAWINGS

In the text which follows, the invention will be described in greater detail by means of an exemplary embodiment shown in the drawing, in which:

FIG. 1 shows a representation of the bit error rate of the bits of class Ib as a function of the metric for various types of transmission channel;

FIG. 2 shows the residual bit error rate of the bits of class Ib as a function of the established metric threshold for various types of transmission channel;

FIG. 3 shows a plot of the frequency of the occurrence of the various metric values in the form of a histogram for a slowly varying channel and for a rapidly varying channel;

FIG. 4 shows a block diagram of the device according to the invention for detecting badly or unreliably transmitted data packets; and

FIG. 5 shows a more detailed circuit diagram of the device according to the invention, on which, in particular, the operation of the state machine shown also in FIG. 4 is based.

### DETAILED DESCRIPTION OF THE PREFERRED EMBODIMENTS

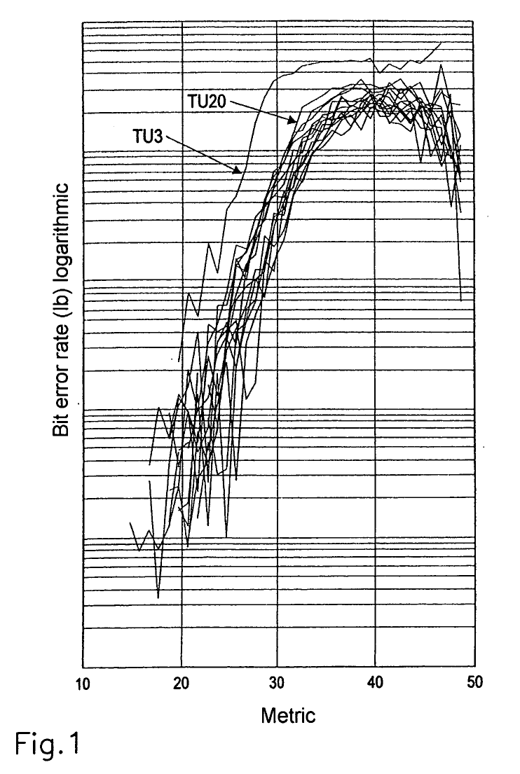

FIG. 1 shows the bit error rate of the bits of class Ib as a function of the metric value, determined for the respective data packet, for various physical transmission channels. The curve designated by TU3 relates to the type “Typical Urban 3 km/h” of transmission channel, that is to say to a mobile radio station which is moved with a speed of approximately 3 km/h in an urban environment. A pedestrian who is moving in an urban environment and calls on his mobile sets up a transmission channel of this type with the base station. The type TU3 of transmission channel (without frequency hopping) is a slowly varying transmission channel because the transmission conditions change only comparatively slowly because of the slow walking speed of the pedestrian. Apart from the type TU3 of transmission channel, the type “static” of transmission channel, in which the mobile radio subscriber does not move at all, also belongs to the slowly varying transmission channels.

The rapidly varying transmission channels, in contrast, include all transmission channels in which a frequency hopping (FH) method is used. In this case, the transmission frequency is changed at the transmitter and receiver in short intervals in accordance with a predetermined scheme in order to improve by this means the ruggedness of the transmission channel with respect to various types of disturbances. Because of the frequency hopping method used, therefore, the TU3, Ideal FH transmission channel also belongs to the rapidly varying transmission channels. Apart from the use of a frequency hopping method, comparatively high speeds of the mobile radio subscriber can also result in a rapid variability of the transmission channel. For this reason, the types TU20, RA250 and HT100 of transmission channel must also be counted as types of rapidly varying transmission channel even when no frequency hopping method is used. The type TU20 (Typical Urban 20 km/h) of transmission channel relates to a subscriber who is moving at a speed of approximately 20 km/h in an urban environment. A mobile radio subscriber moving by car or train at up to 250 km/h in a rural environment is described by the type RA250 (rural area 250 km/h) of transmission channel. HT100 (hilly terrain 100 km/h), in contrast, relates to a subscriber in the mountains who is moving at approximately 100 km/h.

The metric plotted along the horizontal axis in FIG. 1 specifies the number of errors determined for a particular data packet, which is obtained by comparing the Viterbi-decoded and then re-encoded data stream bit by bit with the original encoded data stream.

If the transmission conditions during the transmission of a data packet are poor, the received data packet exhibits a high number of bit errors after it has been decoded. This results in a high value for the metric, or for the number of errors. The higher the metric value, the poorer the quality of the received data. FIG. 1 also shows that the bit error rate determined for some of the transmitted bits, namely for the bits of class Ib, increases monotonically with the metric or the number of errors. The poorer the transmission conditions, the higher will be the metric value or the number of errors and the higher will also be the bit error rate for the bits of class Ib.

When comparing the curves plotted for rapidly varying transmission channels (TU20) and for slowly varying transmission channels (TU3), it is noticeable, however, that in the case of rapidly varying transmission channels, a particular predetermined metric value results in a distinctly higher bit error rate of the bits of class Ib than in the case of slowly varying transmission channels. A data packet which is transmitted via a rapidly varying transmission channel and for which a metric or number of errors of 30 is determined has a much higher bit error rate of the bits of class Ib than a data packet transmitted via a slowly varying transmission channel which has the same metric value 30. The reason for this is that in the case of slowly varying transmission channels (e.g. TU3), the relatively long periods of good transmission alternate with relatively long periods of poor transmission. In the case of rapidly varying transmission channels such as, for example, TU20, in contrast, good and poor transmission periods rapidly alternate. Data bits which are received with good transmission quality and data bits which are received with poor transmission quality alternate during the transmission of one data packet.

In the case of slowly varying data channels, in contrast, the bit errors occur in bursts. If a relatively high metric value is determined for a particular data packet, it can be assumed that a large proportion of the transmitted bits of the data packet is faulty. This is why, in the case of slowly varying transmission channels, the bit error rate determined for a particular metric value is higher than the bit error rate determined for the same metric value in a rapidly varying transmission channel.

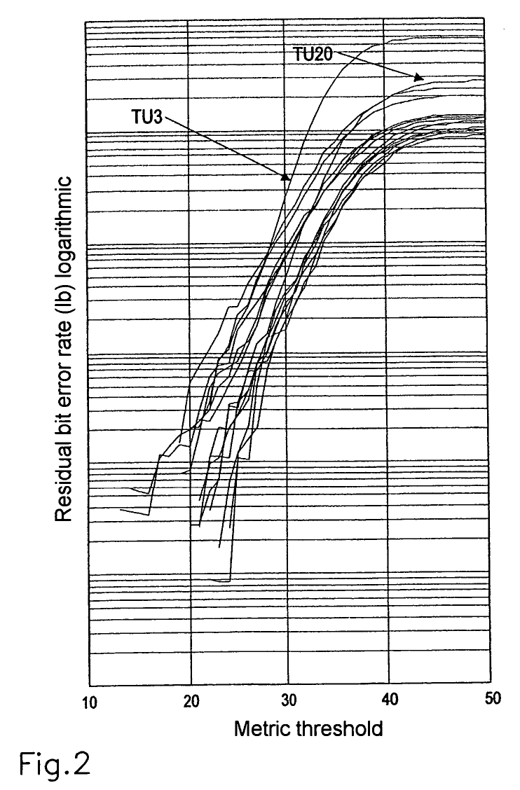

In FIG. 2, the residual bit error rate of the bits of class Ib is plotted as a function of the metric threshold for rapidly varying transmission channels (TU20) and for slowly varying transmission channels (TU3). If a metric threshold is defined, this means that for each received data packet, the metric or number of errors is determined and is compared with the predetermined metric threshold. Only data packets with a metric below the metric threshold are accepted. All data packets with a metric exceeding the metric threshold are discarded.

The residual bit error rate plotted as a function of the metric threshold in FIG. 2, therefore, specifies the residual bit error rate of the data packets accepted, that is to say the residual bit error rate of the data packets with a metric below the metric threshold. In determining the residual bit error rate with respect to the metric threshold having the value 30, for example, all data packets with a metric below the metric threshold of 30 are used. On the other hand, all data packets having a metric of 30 or more are discarded. The result is again that for a predetermined metric threshold, the slowly varying transmission channels (TU3) have a much higher residual bit error rate than the rapidly varying transmission channels (TU20). The reasons for this have already been described in connection with FIG. 1.

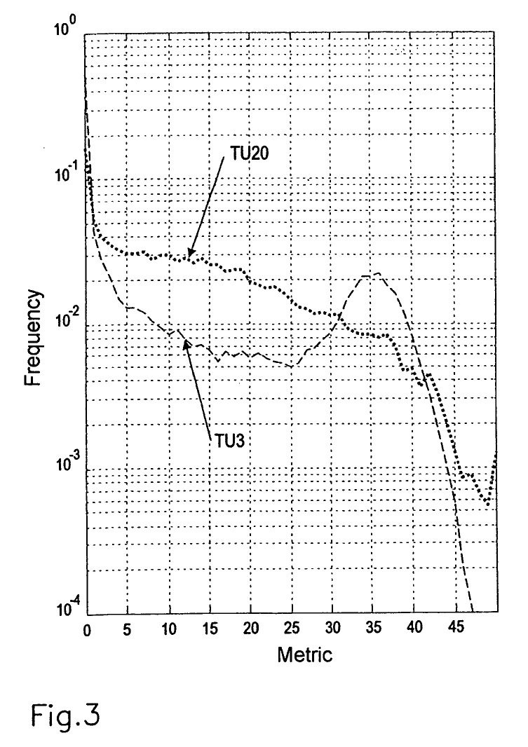

In FIG. 3, the frequency of occurrence of particular metric values is plotted as a function of the metric for a rapidly varying channel (TU20) and for a slowly varying channel (TU3). To create such histograms which represent the transmission characteristics of a particular physical transmission channel in a compact form, the metrics or numbers of errors are determined for a large number of received data packets. Following this, the proportion of data packets with a particular metric in the total number of received data packets is determined.

Considering the histogram of the metrics for various physical channels with the same average signal/noise ratio in time, it is found that the histogram of the metric drops monotonically from zero in the case of rapidly varying channels. Slowly varying transmission channels, in contrast, have two clustering points at zero and at a higher metric value of approximately 35.

It is particularly the frequency of a zero metric which is particularly high in the case of slowly varying channels. The reason for this is that in the case of slowly varying channels, good transmission conditions exist frequently during the entire period of time needed for transmitting the data packet. In the case of rapidly varying channels, in contrast, constant advantageous transmission conditions rarely prevail during the entire transmission of a data packet. During the transmission of a data packet, good and poor bits occur mixed in a large proportion of the cases.

In the case of slowly varying channels, a second clustering point occurs with a metric of approximately 35. In this case, poor transmission conditions exist during the entire transmission of the data packet. It is then a matter of defining a suitable criterion for distinguishing between rapidly varying and slowly varying transmission channels. Because of the great frequency of the metric of zero in both types of transmission channel and because of the more distinct difference in the frequency of the zero metric with rapidly varying and slowly varying transmission channels, it is possible, for determining the type of transmission channel, to detect the frequency of the zero metric within a predetermined set of data frames.

For this purpose, the metric is determined for each incoming data packet and a zero-metric counter is incremented by one for each data packet of the metric of zero. To obtain a statistically significant number of zero metrics, a large number of data packets must be evaluated. A successful method has been to define the period of observation for counting the zero metrics as one superframe which comprises 300 data packets. The number of zero metrics thus determined can then be compared with a predetermined zero-metric limit value which should be placed between the number of zero metrics expected for rapidly varying transmission channels and the number of zero metrics expected for slowly varying channels. If the number drops below this zero-metric limit value, a rapidly varying transmission channel is present with a high probability. If, in contrast, the zero-metric limit value is exceeded, a slowly varying transmission channel is present with a high probability. Using this criterion, the type of transmission channel is known after approximately 300 data packets have been received.

This information can then be utilized for skillfully defining the metric threshold values in order to achieve a bit error rate which is approximately constant independently of the physical transmission channel. FIG. 2 shows that, for achieving a constant residual bit error rate, the metric threshold must be set to a much lower value for a slowly varying transmission channel (TU3) than the metric threshold for rapidly changing transmission channels (TU20).

In principle, the quality requirements for slowly varying transmission channels must be selected more rigorously than those for rapidly varying transmission channels. If it is found that a slow transmission channel (e.g. TU3) is present, the metric threshold value will be set to a more rigorous value, that is to say a lower value. When a rapidly varying transmission channel is present, in contrast, the metric threshold value is set to a higher value. Only data packets having a metric below the specified metric threshold value are accepted. Data packets for which the metric determined exceeds the threshold value must be discarded and then possibly re-requested.

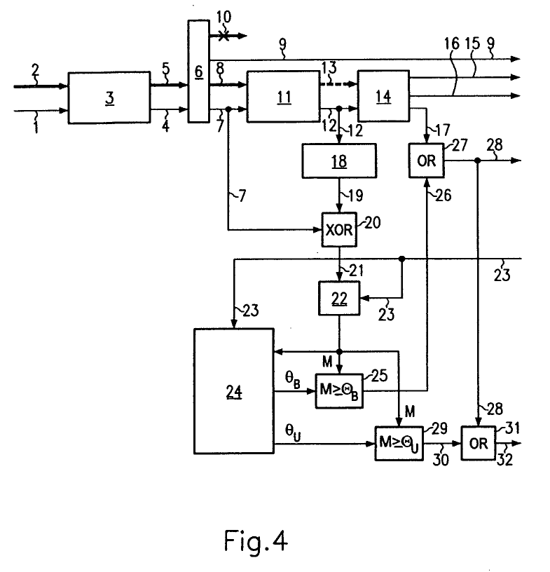

FIG. 4 shows an implementation of the device according to the invention for detecting badly or unreliably transmitted data packets. The stream of received data which, apart from the interleaved encoded bits 1, also comprises supplementary information 2 for these data is supplied to a deinterleaver 3. The deinterleaver 3 in each case performs a permutation of the data symbols belonging to a particular data packet in order to bring them into the correct order for the subsequent decoding. At the output of the deinterleaver 3, a stream of deinterleaved bits 4 and of supplementary information 5 for these data can be picked up.

The incoming bits are divided by the demultiplexer 6 into the stream 7 of encoded bits of class I, into the supplementary information 8 for the bits of class I and into the stream 9 of bits of class II. There is no supplementary information (10) for the bits of class II. The bits of class I are encoded data which must be decoded by the Viterbi decoder 11. The bits of class II, in contrast, are not encoded and are not, therefore, supplied to the Viterbi decoder 11. The bits of class II can be used directly.

The Viterbi decoder 11 decodes the incoming stream 7 of encoded bits of class I and thus generates a stream 12 of decoded bits of class I, and supplementary information 13 for these data. The supplementary information 13 comprises, for example, reliability values (soft outputs) for the individual decoded bits.

The stream 12 of decoded bits of class I and the supplementary information 13 are supplied to the demultiplexer and checksum tester 14. From the stream 12 of decoded bits of class I, the demultiplexer generates two bit streams, namely stream 15 of class Ia bits and stream 16 of class Ib bits. For the bits of class Ia, there is an error protection word for checking the data integrity, and the demultiplexer and checksum tester 14 can thus perform a checksum test or cyclic redundancy check (CRC) for these bits of class Ia. If the checksum test shows that the bits of class Ia have bit errors, the signal 17 which indicates a negative checksum test is set to “1”. There is no error protection word for the bits of class Ib and the data integrity of these bits can thus not be checked with the aid of a checksum test.

To determine the metric or number of errors of the bits of class I, the stream 12 of decoded bits of class I, which can be picked up at the output of the Viterbi decoder 11, is supplied to the convolutional coder 18. The convolutional coder 18 generates a stream 19 of newly convolutionally coded bits of class I which is present at the first input of the XOR gate 20. The stream 7 of encoded bits of class I, which can be picked up at the input of the Viterbi decoder 11, is present at the second input of the XOR gate 20. In the XOR gate 20, the stream 7 of encoded bits and the stream 19 of newly convolutionally coded bits are compared bit by bit. If the two bits present at the two inputs of the XOR gate 20 match, that is to say if a “0” is present at both inputs of the XOR gate 20 or a “1” is present at both inputs of the XOR gate 20, the value “0” appears at the output 21 of the XOR gate 20. If, in contrast, the bit of stream 19 present at the first input of the XOR gate 20 differs from the bit of stream 7 present at the second input of the XOR gate 20, there is a bit error. In this case, the value “1” can be picked up at the output 21 of the XOR gate 20.

The output 21 of the XOR gate 20 is connected to the input of the error counter 22. Every time the value “1” appears at the output 21, the count of the error counter 22 is incremented by one. Using the error counter 22, it is possible to detect the number of bit errors occurring within a data packet, the so-called metric M. For this purpose, after a data packet has been transmitted, the error counter 22 is supplied with a frame pulse 23 which is used as reset/readout pulse for the error counter 22. Every time a frame pulse 23 occurs, the count of the error counter 22 is switched through to the output of the error counter 22 as metric value M. In addition, the count of the error counter 22 is reset to zero.

The state machine 24 is supplied both with the frame pulse 23 and the metric value M. The state machine 24 determines the proportion of data packets with the metric of zero and thus determines whether a slowly varying transmission channel or a rapidly varying transmission channel is present. The state machine 24 then establishes, in dependence on the type of transmission channel, the threshold value Θ_{B} for the detection of bad frames and threshold value Θ_{U} for the detection of unreliable frames. The metric comparator 25 is supplied both with the metric value M and the threshold value Θ_{B}. The metric comparator 25 performs a comparison of M and Θ_{B} and sets the comparison signal 26 for bad frames to “1” when M≧Θ_{B}. In this case, the metric determined or number of errors M determined exceeds the permissible threshold value Θ_{B} and the associated data frame must be discarded.

The comparison signal 26 for bad frames is connected to one input of the OR gate 27. At the other input of the OR gate 27, the signal 17 is present which indicates a negative result of the checksum test. If at least one of the two signals 17 or 26 is at “1”, then the BFI (Bad Frame Indication) signal 28, which can be picked up at the output of the OR gate 27, also assumes the value “1”. The BFI signal 28 indicates that the data packet just received is a bad data packet which must be discarded.

The threshold value Θ_{U} for the detection of unreliable frames is also established in dependence on the type of transmission channel by the state machine 24. The threshold value Θ_{U} for the detection of unreliable frames is set to a lower value than the threshold value Θ_{B} for the detection of bad frames. If, for example, the threshold value Θ_{U}=3 and the threshold value Θ_{B}=5 are selected, this means that a data packet having more than three errors is classified as being unreliable. When more than five errors occur, it is a bad data packet.

The state machine 24 supplies the threshold value Θ_{U} to the metric comparator 29 which performs a comparison of M and Θ_{U} and sets the comparison signal 30 for unreliable frames to “1”, if M≧Θ_{U}. The comparator signal 30 for unreliable frames is, therefore, “1”, if the metric M of the data packet exceeds the threshold value Θ_{U}.

The comparator signal 30 for unreliable frames is supplied to the OR gate 31. At the second input of the OR gate 31, the BFI signal 28 is present which assumes the value “1” if a bad data packet is present. The UFI signal 32, which can be picked up at the output of the OR gate 31, assumes the value “1” if a data packet graded as unreliable is present. The UFI signal 32 assumes the value “1” if the comparator signal 30 for unreliable frames or the BFI signal 28 (or both signals) are set. If, thus, the BFI signal 28 has the value “1” because, for example, there is a negative result of the checksum test or CRC check, this automatically leads to the UFI signal 32 assuming the value “1”. Every bad frame is thus also classified at the same time as an unreliable frame whereas, conversely, not every unreliable frame also needs to be at the same time a bad frame.

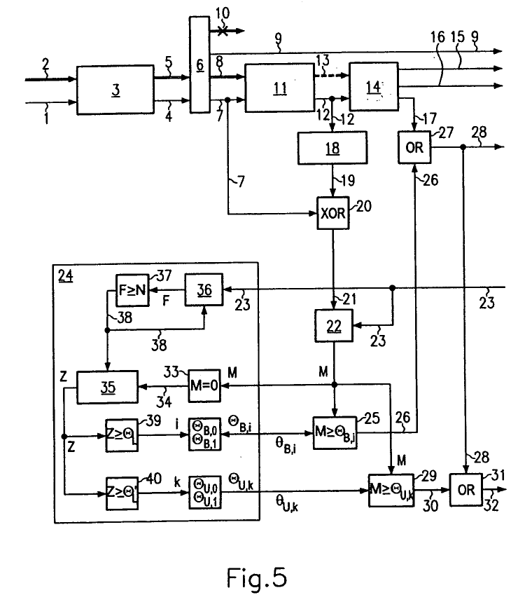

In the text which follows, the operation of the state machine 24 will be represented with reference to FIG. 5. To determine whether a slowly varying or a rapidly varying transmission channel is present, the state machine 24 is supplied with the metric values M determined for the various data packets. In the zero-metric tester 33, a check is made as to whether the data packet just received is a data packet with a metric 0 (M=0) or not. If the metric of the data packet is equal to 0, a counting pulse 34 is transmitted to the zero-metric counter 35. The count of the zero-metric counter 35 is incremented by one with each occurring data packet with the metric 0 during a predetermined period of observation of N data packets. At the end of the period of observation, the count of the zero-metric counter 35 indicates the number Z of zero metrics which have occurred during the period of observation.

The duration of the period of observation is detected with the aid of the frame counter 36, the count of which is incremented by one with each frame pulse 23 occurring. The number F of frames hitherto counted is transmitted to the detector 37 which compares the number F of frames hitherto counted with the predetermined number N, N designating the number of frames within a period of observation. It has been found to be advantageous to specify the period of observation for counting the zero metric as one superframe which comprises N=300 voice frames. As soon as the number F of frames hitherto counted reaches or exceeds the predetermined value N, thus, as soon as F≧N holds true, the detector 37 generates a reset/readout pulse 38 which indicates the end of the period of observation. This reset/readout pulse 38 is supplied to the zero-metric counter 35 which outputs at its output the count Z reached at the time of the occurrence of the reset/readout pulse. In addition, the reset/readout pulse 38 is also supplied to the frame counter 36 where it causes the number F of the frames hitherto counted to be reset to zero.

The number Z of zero metrics present at the end of the period of observation is transmitted both to the zero-metric comparator 39 for bad frames and to the zero-metric comparator 40 for unreliable frames. In the zero-metric comparator 39, the number Z of zero metrics is compared with the limit value Θ_{L}. If N is specified as 300 frames, it is recommended to select a limit value of Θ_{L}=100. If Z reaches or exceeds the limit value Θ_{L}, a slowly varying transmission channel is present because slowly varying transmission channels are distinguished by a high number of zero metrics.

At the output of the zero-metric comparator 39, the comparator result i is present. In the case where Z≧ΘL, that is to say in the case of a slowly varying transmission channel, i assumes the value “1”. If, in contrast, Z<ΘL holds true for the number Z of zero metrics, a rapidly varying transmission channel is present and the comparator result i assumes the value “0”. The comparator result i is supplied to the threshold value table 41. The table (ΘB,0; ΘB,1) supplies the table value ΘB,0 as output value ΘB,i if the input value is i=0. If the input value is i=1, the threshold value ΘB,1 is output at the output of the threshold value table 41.

If a slowly varying channel is present, that is to say if Z≧Θ_{L}, i=1, the received data packets must meet relatively strict quality requirements. The threshold value Θ_{B,1} which is supplied to the metric comparator 25 is thus fixed at a low value. If, in contrast, a rapidly varying transmission channel with Z<Θ_{L}, i=0 is present, the associated threshold value Θ_{B,0}, which is used for detecting bad frames, can be set to a somewhat higher value. For the threshold values Θ_{B,0} and Θ_{B,1} stored in the threshold value table 41, therefore, Θ_{B,0}>Θ_{B,1} holds true. If the metric M exceeds the respective threshold value Θ_{B,i}, the metric comparator 25 signals the presence of a bad frame.

To establish the threshold values Θ_{U,k} for detecting unreliable frames, the number Z of zero metrics is supplied to the zero-metric comparator 40 for unreliable frames, which performs a comparison between the number Z and the limit value Θ′_{L}. If Z≧Θ′_{L} holds true, then this is a slowly varying transmission channel and the comparator result k=1 appears at the output of the zero-metric comparator 40. If, in contrast, Z<Θ′_{L} holds true, a rapidly varying transmission channel is present and the comparator result k assumes the value k=0.

The comparator result k is used for addressing the threshold value table 42 which outputs the threshold value Θ_{U,0} for the case of k=0 and the threshold value Θ_{U,1} for the case of k=1. Again, a stricter threshold value Θ_{U,1} is selected in the case of a slowly varying transmission channel than in the case of a rapidly varying transmission channel so that Θ_{U,1}<Θ_{U,0} holds true. The threshold value Θ_{U,k} is supplied to the metric comparator 29 for unreliable frames which performs a comparison between the metric M and the threshold value Θ_{U,k}. If M≧Θ_{U,k}, the metric comparator 29 signals the presence of an unreliable frame.

I claim:

1. A device for detecting data packets transmitted not reliably without errors in a radio receiver, particularly in a mobile radio receiver, comprising
a convolutional decoder for decoding the received data packets,
means for assessing the quality of the decoded data packets with respect to their freedom from errors,
comparison means which compare parameters characteristic of the quality of the decoder data packets with threshold values, the data packets being accepted, discarded or modified in dependence on the result of the comparison,
means for determining whether the current transmission channel is a rapidly varying transmission channel or a slowly varying transmission channel, and
means for establishing the threshold values for the comparison means in dependence on whether the current transmission channel is a rapidly varying transmission channel or a slowly varying transmission channel.

2. The device as claimed in claim 1, wherein the means for assessing the quality of the decoded data packets comprise a convolutional coder for recoding the decoded data.

3. The device as claimed in claim 2, wherein the means for assessing the quality of the decoded data packets comprise at least one XOR operation by means of which the deviations between the received data and the data recoded by the convolutional coder can be detected.

4. The device as claimed in claim 2, wherein the means for assessing the quality of the decoded data packets comprise an error counter which counts the number of errors as the number of deviations between the received data and the data recoded by the convolutional coder.

5. The device as claimed in claim 4, wherein the comparison means compare the number of errors determined by the error counter with at least one threshold value, the data packets being accepted, discarded or modified in dependence on the result of the comparison.

6. The device as claimed in claim 1, wherein the determining means determine by means of the distribution of the frequencies of the various numbers of errors determined for the data packets whether the current transmission channel is a rapidly varying transmission channel or a slowly varying transmission channel.

7. The device as claimed in claim 1, wherein the determining means determine by means of the proportion of error-free data packets whether the current transmission channel is a rapidly varying transmission channel or a slowly varying transmission channel.

8. The device as claimed in claim 1, wherein the means for determining whether the current transmission channel is a rapidly varying transmission channel or a slowly varying transmission channel comprise a zero-metric counter which counts the error-free data packets within a predetermined number of data packets.

9. The device as claimed in claim 1, wherein the means for determining whether the current transmission channel is a rapidly varying transmission channel or a slowly varying transmission channel comprise at least one comparator which compares the number or the proportion of error-free data packets with a zero-metric limit value, the result of the comparison being used for determining whether a rapidly varying transmission channel or a slowly varying transmission channel is present.

10. The device as claimed in claim 9, wherein in the case where the number or the proportion of error-free data packets is above the zero-metric limit value, a higher quality of received data packets with respect to their freedom from errors is demanded than for the case where the number or the proportion of error-free data packets is below the zero-metric limit value.

11. The device as claimed in claim 9, wherein in the case where the number or the proportion of error-free data packets is above the zero-metric limit value, the threshold values for the comparison means are set to smaller values than for the case where the number or the proportion of error-free data packets is below the zero-metric limit value.

12. The device as claimed in claim 1, wherein the comparison means for determining data packets having a high degree of errors perform a comparison between the parameters characteristic of the quality of the data packets and a first threshold value, and the comparison means for determining data packets having a lower degree of errors perform a comparison between the parameters characteristic of the quality of the data packets and a second threshold value which is smaller than the first threshold value.

13. The device as claimed in claim 1, wherein the transmission channel is a half-rate channel and, in particular, a half-rate voice channel.

14. A mobile radio receiver which comprises a device for detecting data packets transmitted not reliably without errors in a radio receiver comprising
a convolutional decoder for decoding the received data packets,
means for assessing the quality of the decoded data packets with respect to their freedom from errors,
comparison means which compare parameters characteristic of the quality of the decoder data packets with threshold values, the data packets being accepted, discarded or modified in dependence on the result of the comparison,
means for determining whether the current transmission channel is a rapidly varying transmission channel or a slowly varying transmission channel, and
means for establishing the threshold values for the comparison means in dependence on whether the current transmission channel is a rapidly varying transmission channel or a slowly varying transmission channel.

15. A method for detecting data packets transmitted not reliably without errors in a radio receiver, particularly in a mobile radio receiver, comprising the following steps:
a) determining whether a rapidly varying transmission channel or a slowly varying transmission channel is present;
b) assessing the quality of the decoded data packets with respect to their freedom from errors;
c) establishing threshold values for the required quality of the data packets in dependence on the type of transmission channel determined in step a);
d) comparing parameters characteristic of the quality of the decoded data packets determined in step b) with the established threshold values; and
e) accepting, discarding or modifying the data packets in dependence on the result of the comparison.

16. The method as claimed in claim 15, wherein in step d), the number of errors determined for each data packet is compared with at least one threshold value.

17. The method as claimed in claim 15, wherein the distribution of the frequencies of the various numbers of errors determined for that data packets is used for deducing whether a rapidly varying transmission channel or a slowly varying transmission channel is present.

18. The method as claimed in claim 15, wherein the proportion of error-free data packets is used for determining whether a rapidly varying transmission channel or a slowly varying transmission channel is present.

19. The method as claimed in claim 15, wherein the error-free data packets are counted within a predetermined number of data packets, and wherein by comparing the number or the proportion of error-free data packets with a zero-metric limit value, it is determined whether a rapidly varying transmission channel or a slowly varying transmission channel is present.

20. The method as claimed in claim 19, wherein in the case where the number or the proportion of error-free data packets is above the zero-metric limit value, a higher quality of the received data packets with respect to their freedom from errors is demanded than for the case where the number or the proportion of error-free data packets is below the zero-metric limit value.

21. The method as claimed in claim 19, wherein in the case where the number or the proportion of error-free data packets is above the zero-metric limit value, the threshold values for the comparison means are set to smaller values than for the case where the number or the proportion of error-free data packets is below the zero-metric limit value.
